(19) United States
(12) Patent Application Publication
(10) Pub. No.: US 2007/0160845 A1
(43) Pub. Date: Jul. 12, 2007

(54) Electrical device with flame retardant coating and manufacturing method therefor

(75) Inventors: Lothar Schon, Neunkirchen (DE); Martin Rausch, Spardorf (DE); Adelbert Preissler, Uttenreuth (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/329,271

(22) Filed: Jan. 9, 2006

(51) Int. Cl. B32B 17/10; B05D 5/12; B05D 7/00

(52) U.S. Cl. 428/409; 427/407.1; 427/58

(57) ABSTRACT

An electrical device is produced using components that are designed and fabricated of material that is substantially free of flame retardant additives. At least some of the components are coated with a flame retardant coating to give those components fire protection capability that satisfies applicable regulations. The frame retardant coating can be applied to the components either before assembly thereof to form the electrical device, or can be applied to the assembled apparatus.

### BACKGROUND OF THE INVENTION

1. Field of the Invention

The present invention relates to electrical device in general, and in particular to techniques for providing fire protection for electrical device.

2. Description of the Prior Art

Electrical devices such as medical apparatuses and systems of all types, and in particular larger apparatuses and systems such as medical imaging systems such as magnetic resonance imaging (MRI) systems, computed tomography (CT) systems, C-arm x-ray systems, positron emission tomography (PET) systems, and single photon emission computed tomography (SPECT) systems are required by statutes and regulations to have appropriate fire protection. Such fire protection also is necessary in most instances to obtain insurance coverage.

A requirement for Underwriters Laboratory (UL) approval of medical apparatuses is, among other things, that the casing or housing parts of those apparatuses must have a high level of flame retardation capability.

For example, casing or housing parts behind which electronics with a capacitor of more than 15 watts are located, the classification UL 94 VO is stipulated. For “decorative” housing parts, meaning housing parts behind which a firing closure is already located, or no electronics are located, the classification UL 94 HB is stipulated.

In order to comply with the stipulated flame retardation requirements, conventionally housing parts have been produced from a metal or a synthetic material, such as plastic that is provided by the manufacturer of the material with appropriate additives to achieve the necessary flame retardation capability. The designs and configurations that can be achieved with such conventional material, as well as the selection of the material itself, are significantly limited by this conventional approach. Increased costs may also be associated with the use of such conventional material. Moreover, in the case of synthetic materials, it is required to maintain a minimum material thickness, which in turn limits the size of certain components, due to the weight associated with the requisite thickness of material. This requirement also limits the size of components that must be supported in a cantilevered fashion, for the same reason.

The use of flame-retardant synthetics may also involve health and ecological disadvantages in the processing or disposal of such components, because often the additives that are used to achieve the flame retardant properties are halogen-based and/or antimony based compounds.

### SUMMARY OF THE INVENTION

It is an object of the present invention to provide an electrical device that satisfies the requisite requirements for flame retardation that avoids or minimizes the aforementioned problems associated with conventional apparatuses of that type.

The above object is achieved in accordance with the present invention by an electrical device having housing or casing parts that are subject to the aforementioned regulations that are made of material that is substantially free of flame retardant additives. These housing or casing components are coated with a flame retardant coating.

In accordance with the invention, the material and material dimensions of the housing parts or components can be selected primarily for achieving desired mechanical characteristics and/or with regard to the ability to work or shape the material into the desired form. The flame retardant coating is added after the component has been fabricated, and thus does not impose significant limitations in the design or manufacturing process for the overall system. As used herein, therefore, substantially no flame retardant additives” means a level of flame retardant additives that does not inhibit the structural concerns associated with design and manufacture of the components.

The flame retardant coating can be applied to the overall electrical device, after assembly thereof, in order to satisfy the applicable regulations, or the flame retardant coating can be applied to individual components or groups of components before assembly to satisfy the applicable regulations. If necessary, after the coated components have been assembled, flame retardant coating can be applied at selected locations of the assembled medical apparatus if locations still exist at which the applicable regulations are not satisfied.

The method for manufacturing a medical apparatus in accordance with the present invention can also be applied to electrical devices in general that contain housing or casing parts made of plastic materials (e.g. transformers, switch gears, television). This device may have to comply with different regulations compared with medical apparatus.

### DESCRIPTION OF THE DRAWINGS

FIG. 1 is a flowchart showing the steps of first embodiment of a method for manufacturing a medical apparatus in accordance with the present invention.

FIG. 2 is a flowchart showing the steps of a second embodiment of a method for manufacturing a medical apparatus in accordance with the present invention.

### DESCRIPTION OF THE PREFERRED EMBODIMENTS

The following embodiments are explained using the example of a medical apparatus, but it will be understood that the description is equally applicable to all types of electrical devices, as described above.

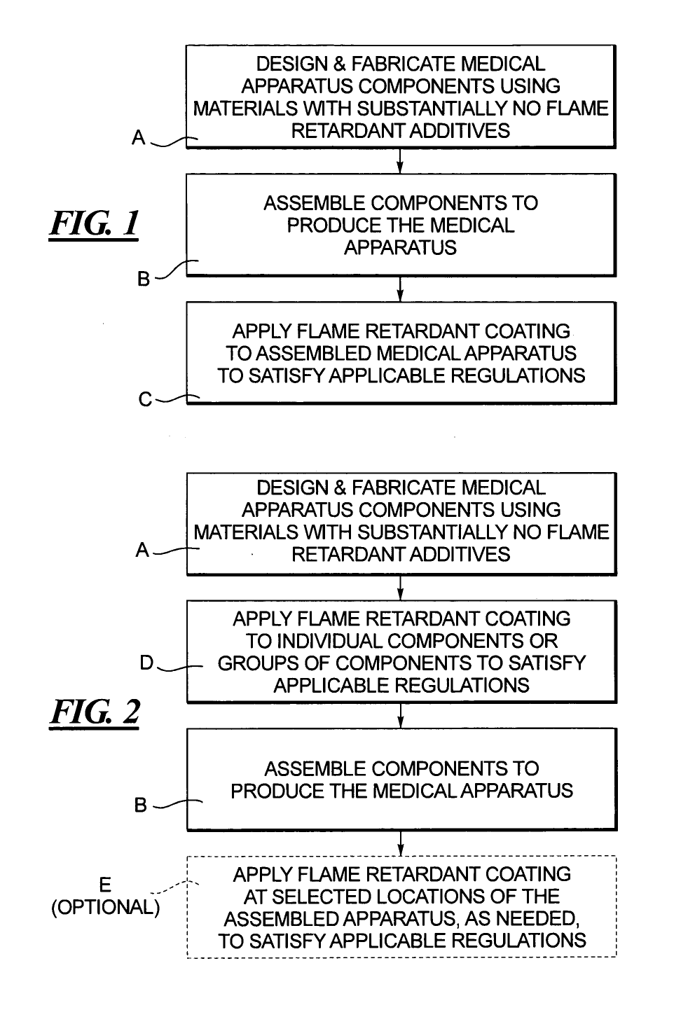

As illustrated in FIG. 1, in a first embodiment of the inventive method for manufacturing a medical apparatus, in step A the components of a medical apparatus are designed and fabricated using materials with no flame retardant additives. The components are therefore designed and fabricated to have mechanical and structural properties achieved by materials that are free of flame retardant additives.

In step B, the components are assembled to produce the medical apparatus. In step C, flame retardant coating is applied to the assembled medical apparatus to satisfy the applicable regulations regarding fire protection. The flame retardant coating can be applied to cover the entirety of the apparatus, or can be applied at selected locations, dependent on the nature of the electrical components that are contained in or housed by the various apparatus components. In order to give the overall apparatus a uniform appearance and/or to simplify the coating procedure, the overall apparatus may be coated with the flame retardant coating even though such an overall coating my not be strictly necessary in order to comply with the applicable regulations.

A second embodiment of the inventive method is illustrated in the flowchart of FIG. 2. This second embodiment begins with the same step A as the embodiment shown in FIG. 1, wherein the medical apparatus components are designed and fabricated using materials with no flame retardant additives. In the embodiment of FIG. 2, the flame retardant coating is applied to individual components, or groups of components, to satisfy the applicable regulations. The coating is applied, for example, to components or groups of components that will house or contain electronics that must be provided with fire protection under the applicable regulations.

As in the embodiment of FIG. 1, the components are then assembled, in step B, to produce the medical apparatus.

The embodiment of FIG. 2 also includes an optional step E, wherein flame retardant coating is applied at selected locations of the assembled apparatus, as needed, in order to satisfy applicable regulations. Even though the individual components or groups of components have already been coated with a flame retardant coating in the embodiment of FIG. 2, there may be small locations that must be left free of such coating, in order to facilitate assembly, and if such locations exist, these locations can then be coated in step E.

The flame retardant coating may be of the type that foams and carbonizes in a temperature range below the ignition temperature of the material being protected, thereby producing a non-flammable, thermally-insulating coating that faces toward the flame, that protects the coated material from the direct effects of the flames. Another type of flame retardant coating is known that is suitable for use in accordance with the invention, which chemically separates in the presence of flames to release water. The water release not only provides an extinguishing effect, but also the chemical reaction resulting in the release of water consumes energy, thereby lowering the heat that reaches the material beneath the coating.

The coating material can be a dispersion that is applied by conventional techniques such as painting, spraying, rolling, etc. The coating can ensue at all sides of the components that are accessible to the coating procedure, or can be applied only on the side of the component that faces the electronics. For coloring or moisture protection, the coating can be varnished with a top coat.

The flame protection for the components to which the coating is applied can be adjusted by the layer thickness of the applied coating. The use of the applied coating allows the material selection and fabrication of the components to be undertaken without the increased thickness and other disadvantages associated with materials that contain a flame retardant additive. More cost-effective and semi-finished components can be used, thereby simplifying the fabrication and assembly process. In particular semi-finished products can be used as the components, or to form parts of the components, that have a lower thickness than is required for the aforementioned UL 94 VO classification. In general, weight, cost and space savings are achieved by the use of the coating.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for manufacturing a an electrical device comprising the steps of:
designing and fabricating a plurality of electrical device components using materials that are substantially free of flame retardant additives; and
applying a flame retardant coating to at least some of said electrical device components to give said at least some of said electrical device components fire protection capability that satisfies applicable regulations.

2. A method as claimed in claim 1 comprising the step of assembling said components to produce said electrical device, and applying said flame retardant coating to said at least some of said components before assembling said components to produce the electrical device.

3. A method as claimed in claim 2 comprising applying flame retardant coating at selected locations of the assembled medical apparatus as needed to satisfy applicable regulations for the assembled electrical device.

4. A method as claimed in claim 1 comprising the step of assembling said components to produce said electrical device, and applying said flame retardant coating to said at least some of said components after assembling said components to produce the medical apparatus.

5. A method as claimed in claim 1 comprising applying a colorant coating over said flame retardant coating.

6. A method as claimed in claim 1 comprising applying a moisture-protection coating over said flame retardant coating.

7. A method as claimed in claim 1 wherein the step of applying a flame retardant coating comprises applying a flame retardant coating that foams and carbonizes in a predetermined temperature range.

8. A method as claimed in claim 1 wherein the step of applying a flame retardant coating comprises applying a flame retardant coating that undergoes a chemical reaction to release water in a predetermined temperature range.

9. A method as claimed in claim 1 comprising assembling said components to produce a medical apparatus, as said electrical device.

10. An electrical device comprising:
a plurality of electrical device components comprised of material that is substantially free of flame retardant additives; and
a flame retardant coating applied to at least some of said electrical components to give said at least some of said electrical components fire protection capability to satisfy applicable regulations.

11. A medical apparatus as claimed in claim 10 wherein said flame retardant coating comprises a coating that foams and carbonizes in a predetermined temperature range.

12. A medical apparatus as claimed in claim 10 wherein said flame retardant coating comprises a coating that undergoes a chemical reaction to release water in a predetermined temperature range.

13. An electrical device as claimed in claim 10 wherein said plurality of electrical device components are a plurality of medical apparatus components.
